(19) United States
(12) Patent Application Publication
(10) Pub. No.: US 2009/0228572 A1
(43) Pub. Date: Sep. 10, 2009

(54) SYSTEM AND METHOD FOR CREATING AND TRACKING RICH MEDIA COMMUNICATIONS

(76) Inventors: Wayne Wall, Hopkinton, MA (US); Richard DiBona, Watertown, MA (US); Thomas Edward Cmejla, Stow, MA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 11/916,169

(22) PCT Filed: Jun. 15, 2006
(86) PCT No.: PCT/US06/23415

§ 371 Date: May 22, 2008

(30) Foreign Application Priority Data
Jun. 15, 2005 (US) 60690663

(51) Int. Cl. G06F 17/00; G06F 15/16

(52) U.S. Cl. 709/218; 715/202; 715/764

(57) ABSTRACT

The present invention includes a system, methods, and technology platform for instantly creating, delivering, updating, deploying, and inherently tracking one or more unique, multimedia rich, email and web-based communications campaigns or rich media presentations—all without any technical knowledge. Each rich media presentation created with the invention may consist of a unique, pre-defined collection of separately trackable interactive content elements which are programmatically collected, arranged and displayed as part of a complete audiovisual presentation. Upon distribution of such a presentation, tracking data from the viewer's interaction with the presentation may be retrieved.

### RELATED APPLICATION

The present application claims the benefit of U.S. Provisional Application No. 60/690,663 filed on Jun. 15, 2005 which is incorporated herein by reference.

### TECHNICAL FIELD

The present invention is directed towards the creation and dissemination of audiovisual multimedia presentations and more particularly towards a system and method for creation, updating, tracking, and display customization of interactive rich media multimedia communications presentations.

### BACKGROUND

In today's competitive environment, businesses and other organizations spend considerable time and effort on direct marketing and communications and otherwise presenting themselves and their message to others in a professional manner so as to create a specific action response or result. Many larger organizations and businesses employ internal departments or outside professional services firms that create professional-looking presentations for various direct marketing campaigns, organizational communications, shareholder communications, market and product research, find raising, employee training, political campaigns and other purposes. The presentations are typically print brochures, direct mail pieces, text press releases, graphic email newsletters and/or CD's or DVD's containing multimedia presentations.

Traditionally, the multimedia presentations containing audiovisual communications were compiled by direct marketing firms on a compact disc (CD) or digital versatile disc (DVD) and delivered to the target audience via courier or the U.S. mail. Typically, these marketing concerns used postal mail, telemarketing, and Email campaigns to generate a list of interested prospects. The manufacturing process of placing the electronic materials onto CDs/DVDs can require several months' time and considerable expense, followed by additional expense to deliver the material to the prospect. Once the multimedia presentation is delivered, tracking its effectiveness requires follow up telephone, Email, or postal mail contact, each of which may result in a very low response rate. Such manual follow up methods are costly and time consuming, thereby reducing the benefit of the marketing campaign.

One of the most popular applications used to create interactive rich media presentations is Macromedia's Flash® software. Flash allows skilled designers and developers to integrate video, text, audio, and graphics into interactive multimedia marketing pages and rich media presentations. According to Macromedia, “Flash is the world's most pervasive software platform, used by over one million professionals and reaching more than 97% of Internet-enabled desktops worldwide, as well as a wide range of devices”. Recent technological improvements in streaming data over the Internet to Web visitors have further increased the popularity of rich media multimedia presentations that are delivered over the Web.

Despite its technical efficiencies and capabilities, creating, updating, delivering and tracking Flash rich media presentations displayed from a Web page as well as customizing the viewer interface in which such presentations are displayed can be difficult, expensive, and time consuming. Doing so requires an extensive technical knowledge of Flash action scripting (a Flash client-side programming language based on JavaScript), PHP (Hypertext-Preprocessor—a widely-used general-purpose programming language that is especially suited for Web development and can be embedded into HTML) and other programming and script languages. Therefore, it is typically necessary for the actual producer of the rich media presentation content to deliver all of the source materials to skilled designers and developers to create or update the presentation and synchronize the Web page code with the materials displayed. Additional database development and coding and software programming is required to capture information and statistics pertaining to user interaction with the new presentation beyond just the basic number of Web site visitors who visited the new or updated page.

Once development is complete, the updated rich media presentation content files need to be uploaded to the server hosting the Web page. These steps can result in additional expense and the loss of valuable time to make new content available to Web page viewers. These requirements have impaired the ability of organizations, especially small and medium-sized organizations, to implement attractive and appealing audiovisual online communications campaigns quickly and affordably and the effectiveness of such campaigns could not be efficiently measured.

Therefore, a need exists for a technology application that simplifies for an individual engaged in rich media direct marketing or communications the entire process and specialized technical skills presently required for creating, updating, customizing and distributing multimedia-rich, interactive Web and Email communications and marketing presentations in a timely and cost-effective manner together with automated tracking and reporting of summary and individual user activity and interactions with the rich media presentation.

### SUMMARY OF THE INVENTION

The present invention responds to this and other needs by providing the means for individuals who do not possess the technical skills typically required to create, maintain, and deploy rich media Web page or Email presentations to quickly and cost-effectively create, update, track, customize the display of and instantly deploy and deliver such interactive multimedia presentations to a chosen audience. The present invention provides all of these capabilities on a 24-hour per day basis, seven days a week, all without any specialized design skills, technical knowledge or programming skills beyond the ability to connect to the Internet and use an Internet browser.

In accordance with these and other aspects, the present invention relates to systems, methods, and a technology platform used to quickly create, update, track, display and deliver interactive multimedia content on a computer system comprising the acts of selecting specific audiovisual content elements, including but not limited to, Flash movies, graphics, text, logo images and the URLs of target hyperlinks, wherein each element is tracked automatically.

Additionally, customizable user action elements (Action Links) can be provided for use with the invention. For example, an “Email this Presentation” action link allows the person viewing the presentation to send an HTML email to a friend that contains a hyperlinked “snapshot” image of the multimedia presentation. This action link supplies implementers of the invention with the ability to track and collect Email addresses and comments of senders and recipients of the presentation for use as a viral marketing delivery system. Other links with similar or different functions may also be incorporated into a presentation, such as a “Learn More” link, where a rich media presentation viewer may request additional information, or a “Send Us Your Opinion” link to collect feedback from the presentation's viewers. Such links could be customized to collect other useful information from the targeted audience, such as survey question responses, donation responses, sales leads, product orders, and other information as it would apply to a specific rich media presentation as part of a marketing campaign.

Using the invention, email addresses and any comments or other information provided by the audience are automatically collected and displayed in the invention's Dashboard online user interface via an Internet browser and can be used for reporting, analysis, lead capture and other useful purposes. Additionally, the appearance of the rich media presentation may be customized through the use of drag and drop elements within the invention's Dashboard. Additionally, the static image displayed when an invitation to view a rich media Presentation is sent by Email (referred to as a “Snapshot”) can be changed instantly using the invention with the click of a button. Finally, the invention relates to performing these tasks on a client-server computer system having a client computer system and server computer system that communicate using data encryption techniques to safeguard information and preserve privacy. The techniques used for account creation and management enable secure access to the technology platform in order for users of the invention to create, edit and automatically track the rich media communications which are the subject of the invention.

### BRIEF DESCRIPTION OF THE DRAWINGS

These and various other features as well as advantages, which characterize the present invention, will be apparent from a reading of the following detailed description and a review of the associated drawings.

FIG. 1 is a diagram of an illustrative embodiment of the technology platform and network interactions used when the invention is implemented.

FIG. 2 is a block diagram of the processes used within an illustrative embodiment of the invention's Dashboard Content Manager capabilities.

FIG. 3 is a flowchart of the events that take place from the time a recipient clicks a link to a presentation to the time the presentation is rendered in the recipient's browser.

FIG. 4 is a block diagram of the processes used within an illustrative embodiment for the capture of statistical data related to a viewer's interactions with a presentation rendered by the invention's Viewer Digital Canvas.

FIG. 5 is a block diagram of the processes used within an illustrative embodiment of the invention's Dashboard Report Manager capabilities.

### DETAILED DESCRIPTION

The present invention includes methods, systems, and a technology platform to create, update, track, customize the display of, render at run time and deploy and distribute rich multimedia interactive communications and marketing presentations using the Internet—instantly without web design or programming knowledge or skills.

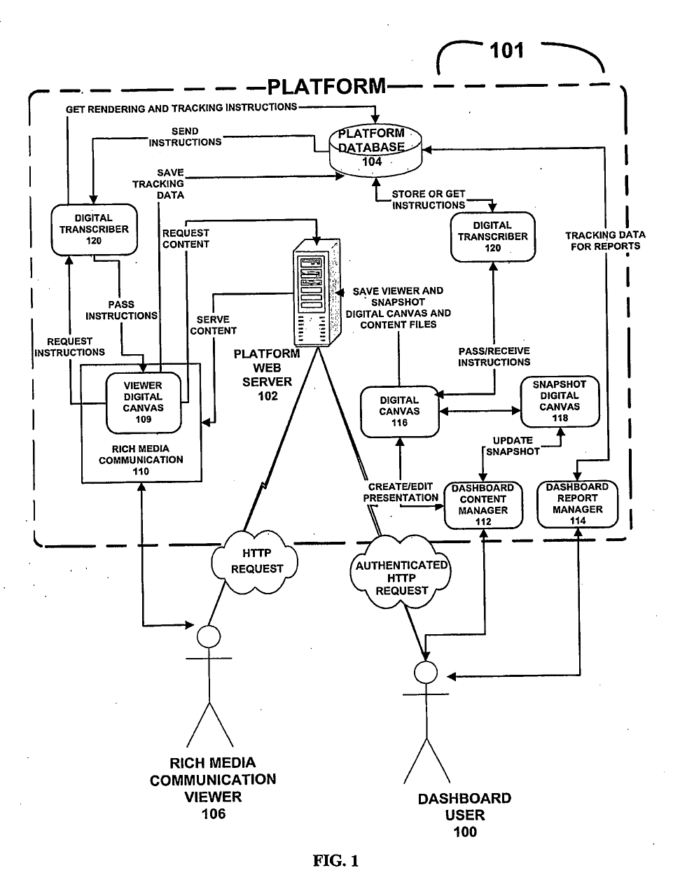

In an illustrative embodiment of the present invention, an account is established for an implementer of the invention that permits the implementer to access the invention's Technology Platform quickly and securely in order to create, update, track and deploy rich media communications and marketing presentations. The Technology Platform uses a web-based communications infrastructure for implementers to access all of its functionality and implement and manage web-based (or other) marketing communications campaigns with only the ability to use an Internet browser and to connect to the Internet. While this detailed description discusses the invention's capabilities with respect to rich media communications, it is envisioned that the invention could easily be adapted for other purposes, such as dynamically rendering and/or custom web pages at runtime. With reference to FIG. 1, an illustrative embodiment of the invention's Technology Platform consists of:
One or more uniquely configured Platform Databases 104 used to store instructions used to render rich media presentations at runtime and the tracking data that applies to content elements contained within such presentations.
One or more Platform Web Servers 102 used to manage the communications between the various components of the Technology Platform with the Internet browsers of both those who define and track rich media presentations using the invention 100 and the recipients or viewers of such presentations 106 using HTTP protocol. The Platform Database may be located on the Platform Web Server computer or on other networked computers.
A Digital Canvas 116, which contains the code and logic necessary to create and render highly customizable interactive Rich Media Presentations without technology skills. The Digital Canvas allows the user to construct these presentations by placing content elements anywhere on a custom sized canvas. As a result, every presentation can be completely unique and tailored to the user's needs. The Digital Canvas also contains logic to automatically track end-user interaction with any content item the Presentation Designer places on the canvas. Further, the Digital Canvas communicates with the Digital Transcriber 120 to store information about the custom canvas, content items and tracking mechanisms in the Platform Database. Scaled down iterations of the Digital Canvas have been recompiled as the Snapshot Digital Canvas 118 and the Viewer Digital Canvas 109. For ease of deployment in the form of the smallest possible file sizes, the Viewer Digital Canvas 109 and Snapshot Digital Canvas 118 contain only the code necessary to fulfill their intended tasks. More specifically, the code necessary to track content items and save presentations in coordination with the Digital Transcriber 120 has been removed to reduce deployment file size as much as possible.
A Digital Transcriber 120, which contains the code and logic to turn Rich Media Presentations into easily storable instructions and back again. The Digital Transcriber works with the Digital Canvas 116 by recording the placement, formatting, and content of each content item placed by the user onto the Digital Canvas into a set of instructions necessary to render the Rich Media Presentation. Upon demand by the Viewer Digital Canvas 109 or the Snapshot Digital Canvas 118, the Digital Transcriber retrieves the rendering instructions from the Platform Database and feeds them to the Digital Canvas for rendering.
A Snapshot Digital Canvas 118, which is a pre-programmed palette used to render and display existing rich media presentations to those who manage them for the purpose of capturing a selected frame of the presentation and converting it into a static image file used to represent the presentation within an HTML email message. The Snapshot Digital Canvas is a subset of the Digital Canvas 116 and contains only the code and logic necessary to render a Presentation and store an image of the Presentation.
A Viewer Digital Canvas 109, which performs the tasks necessary to render in real time a pre-defined Rich Media Presentation at runtime on the presentation viewer's computer within the viewer's Internet browser. The Viewer Digital Canvas also contains the code necessary to track end-user interaction with the Presentation. This tracking is sent to the Platform Database 104 instantly upon any interaction with the Presentation, i.e. clicking links or buttons, filling out forms, or watching videos. The Viewer Digital Canvas is a subset of the Digital Canvas 116 and contains only the code and logic necessary to retrieve Presentation rendering instructions from the Digital Transcriber 120, render the Presentation almost instantly in real time, and save tracking and end-user interaction data to the Platform Database.
One or more Rich Media Presentations, which are pre-defined collections of interactive rich media content elements, such as audio files, video files, images, hyperlinks and text, rendered client side at runtime within a viewer's or user's browser by the Viewer Digital Canvas 109 or Snapshot Digital Canvas 118 following the instruction set stored for each presentation. Each Rich Media Presentation is the result of the rendering instructions saved by the Digital Transcriber 120.
One or more Rich Media Communications 110, each of which is the assembled and rendered Rich Media Presentation displayed within an HTML page and viewed and interacted with through the use of an Internet browser.
The User Dashboard is a collection of tools displayed within an Internet browser that is used by implementers of the invention to define and customize Rich Media Presentations and to access statistical data in order to generate reports pertaining to each Rich Media Presentation created. The User Dashboard consists of the Dashboard Content Manager 112 and the Dashboard Report Manager 114.
The Dashboard Content Manager 112 is a collection of specially programmed HTML form-based tools used to create, edit, customize, deploy and distribute Rich Media Communications and which provides users with access to the Digital Canvas 116 and which renders the Snapshot Digital Canvas 118 when requested.
The Dashboard Report Manager 114 is a collection of specially programmed HTML form-based tools used to help measure the effectiveness of and track the interaction with each Rich Media Communication and to generate pre-formatted reports on request.

The technology provided by the invention allows marketing or other communicators to create, update, deploy, distribute and track Rich Media Presentations without any technical knowledge, including design skills, programming skills, or database skills. In the illustrative embodiment, the User Dashboard is accessed through a user's web browser connected to the Internet, as depicted in FIG. 1. When a User Dashboard account is created a URL is provided to the user that opens a log-in web page hosted on the Platform Web Server 102. FIG. 1 is a representation of the network environment for an illustrative embodiment of the invention. A Dashboard user 100 opens an Internet browser and directs the browser to the URL of the Platform Web Server hosting the customer's Dashboard. The Platform Web Server 102 displays an authentication dialog to the user. In the authentication dialog, the Dashboard user types in the user name and password for the Dashboard account the user wants to access and clicks OK. Such authentication dialog may be encrypted for transmission. Platform Web Server 102 authenticates the customer, retrieves the information pertaining to the customer's Dashboard account and displays the Dashboard's graphical user interface in the user's Internet browser with the authenticated user's account data displayed.

The first task typically required of a Dashboard User 100 in order to create a Rich Media Presentation is to provide a unique title to the presentation. To ensure the uniqueness of the title the desired title is checked by the Platform Web Server to see if the title already exists. If it does, the Dashboard User must provide a different title. Once the title is accepted as unique it is stored in the Platform Database 104, which becomes the unique sub domain through which the Rich Media Communication is accessed. All requests to the Platform Web Server 102 are routed to a specific page by special code installed on the Platform Web Server 102. This specific page reads the sub domain from the request and matches it to a Rich Media Presentation title in the database. The appropriate Rich Media Presentation is then assembled, rendered and displayed at runtime client side as a cohesive Rich Media Communication.

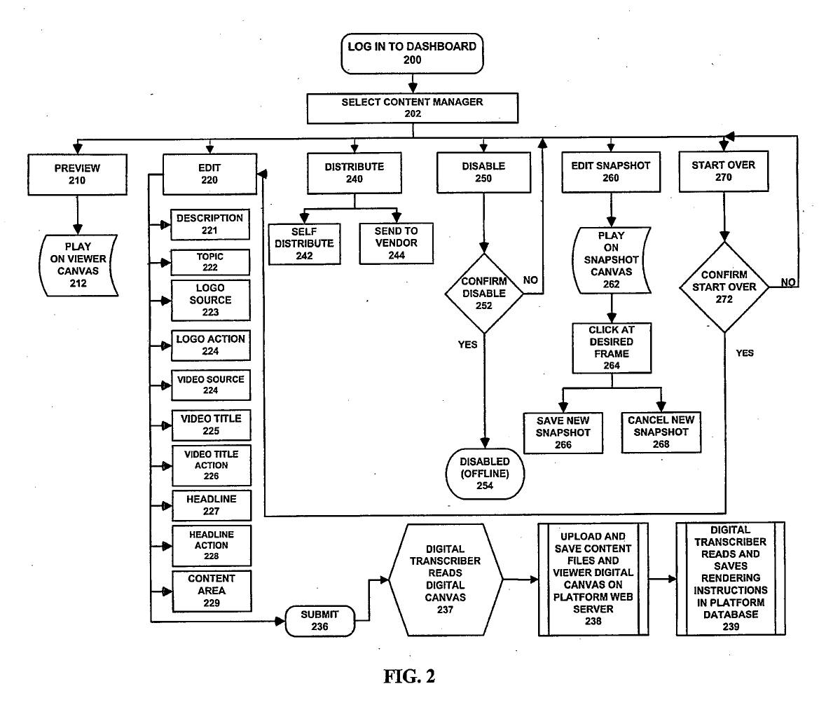

The User Dashboard's Content Manager 112 component allows users without technical training, assistance or supervision to create and edit Rich Media Presentations from the Digital Canvas 116. FIG. 2 shows the processes for editing 220 (the same process can be used for creating a presentation) Rich Media Presentations using the Content Manager component of the Dashboard. The Content Manager allows users to browse to and select audio files, video files, and images on the user's personal computer or a computer network and for the user to provide text and hyperlinks to incorporate within the Rich Media Presentation. It also allows Dashboard users to drag and drop design elements for the presentation onto the present invention's Digital Canvas 116 in order to customize the display of the presentation.

Each presentation may be deployed and distributed using the processes depicted in FIG. 2. A presentation is created and edited by taking the Edit path 220. Once all of the desired content elements are defined for a presentation, the Dashboard user clicks Submit 236, the Digital Transcriber 120 reads the placement and formatting of each element, step 237, and converts them into the form of instructions necessary to render the Presentation. The Digital Canvas then uploads the collection of content elements as files and stores them in the server's file system, step 238, and then uploads and stores the instructions associated with this presentation in the Platform Database 104, step 239. The content elements are indexed by the user account's unique Client ID and by the unique Presentation ID and stored in the Platform Database 104.

As the Dashboard user 100 changes one or more of the Rich Media Presentation's content elements, the Presentation is updated dynamically on the Digital Canvas so that it may be previewed immediately after the updates are applied. Further, unless the Presentation is currently disabled, all changes made within the Dashboard are immediately visible to the next visitor who views the Rich Media Presentation.

Elements that may be directly edited within the Dashboard include:

Description 221 to identify the nature of the Presentation.

Topic 222, which could be used in the email subject line whenever a presentation recipient clicks the “Email This Presentation” Action Link.

Logo Source 223 and Logo Action 224, which may be a logo image and a hyperlink to use for the image within the Presentation as the target URL whenever the logo source image is clicked.

Video Source 225, Video Title 226 and Video Title Action 227, which would be the source file for a video element, the title displayed for the video element and the target URL used whenever the video title is clicked in the Presentation.

Headline 228 and Headline Action 229, which could be text displayed within the Presentation that is formatted as a title and the target URL used whenever the Headline is clicked within the Presentation.

Content Area 230, which could be a scrollable text box containing the textual content the Dashboard user 100 wants to display within the Presentation.

Other elements, both editable and static may be included in the illustrative embodiment and are within the scope of the present invention.

Another aspect of the invention relates to the ability of the Dashboard user 100 to customize the look and layout of the Rich Media Presentation, including the ability to specify custom colors, content layout arrangements, and the size of individual Presentation components directly within the Content Manager component of the User Dashboard without the use of third-party skins that have previously been required in order to change the look and feel of a media player's display without programming knowledge.

Other design elements, including text labels, Video player areas, Images, Action Buttons, and hyperlinks can be dragged and placed on the Digital Canvas and positioned according to the Dashboard user's needs. Further, formatting options such as font face, color, bold, italic, bullet points, and other standard options can be applied to most elements. A Presentation can be of any height and width the Dashboard user specifies and can have a specified background color or background image.

When the Dashboard user 100 clicks the Submit button 235 on the Content Manager page, any new content elements that need to be uploaded (images and movie files, for example), get uploaded via HTTP and are stored in the Platform Web Server's file system 102. The Digital Transcriber converts all rendering instructions on the Digital Canvas and saves them in the Platform Database 104 tables according to the unique ID for this Rich Media Presentation. Both the tracking information and the presentation information are updated automatically without any further interaction by the Dashboard user 100.

The presentation that will be rendered to the viewer can be previewed, step 210 and tested by the Dashboard user 100 using the same technology that renders the presentation to a viewer 106, step 212.

The illustrative embodiment's Dashboard Content Manager also provides tools that can be used to distribute invitations to view Rich Media Presentations, step 240. The user may self distribute the email invitation to prospects, step 242 or package everything needed and send the information to a third-party direct email vendor, step 244.

If, at any time, the user 100 wants to suspend access to the Presentation 240, the Dashboard Content Manager allows the user to do so with a click of a button, step 250 and a positive response to a confirmation message, step 252. Any recipients 106 attempting to view a disabled presentation receive an error message that the presentation is not available without any further action by the Dashboard Content Manager user 100.

Another aspect of the invention relates to the ability of the Dashboard user 100 to create a Snapshot, which is a static image used to represent the Rich Media Presentation within an HTML email. This digital Snapshot can also be managed within the Dashboard Content Manager. When a Dashboard user 100 clicks the button to edit a presentation's Snapshot 260, a Snapshot Digital Canvas 118 retrieves the instruction set and content elements from the Platform Database 104 and Platform Web Server 102, renders them and displays them within the Dashboard Content Manager 262. A Snapshot Digital Canvas is similar to a Viewer Digital Canvas 109 except that it contains the necessary programming that allows it to capture the frame of the presentation displayed to the user when the click occurs, step 264. This click triggers the process used by the Snapshot Digital Canvas to compile a byte-by-byte static image in JPG format, using Flash ActionScript code. If the Dashboard user 100 is satisfied with the snapshot, the user clicks a button to save the snapshot, step 266 and the Snapshot Digital Canvas saves the image on the Platform Web Server 102 using graphics libraries and PHP code. The Dashboard User 100 also has the option to discard the image without saving it, step 268. This allows the Dashboard User 100 to try again or abandon the effort and retain the existing Snapshot.

The illustrative embodiment also allows the Dashboard User 100 to completely clear a presentation's instructions and content elements and start over, step 270. Once the user confirms the desire to start over, step 272, all of the items placed on the Digital Canvas are removed and the user starts the process of creating a new presentation, step 220.

Therefore, creating and editing a Rich Media Presentation in accordance with the present invention requires nothing more than logging in to the Dashboard 200, selecting the Dashboard Content Manager component 202, selecting files, typing text and clicking a button to complete the process. The tracking mechanisms used for the elements within the presentation are created and managed programmatically by the present invention without any involvement of the user 100.

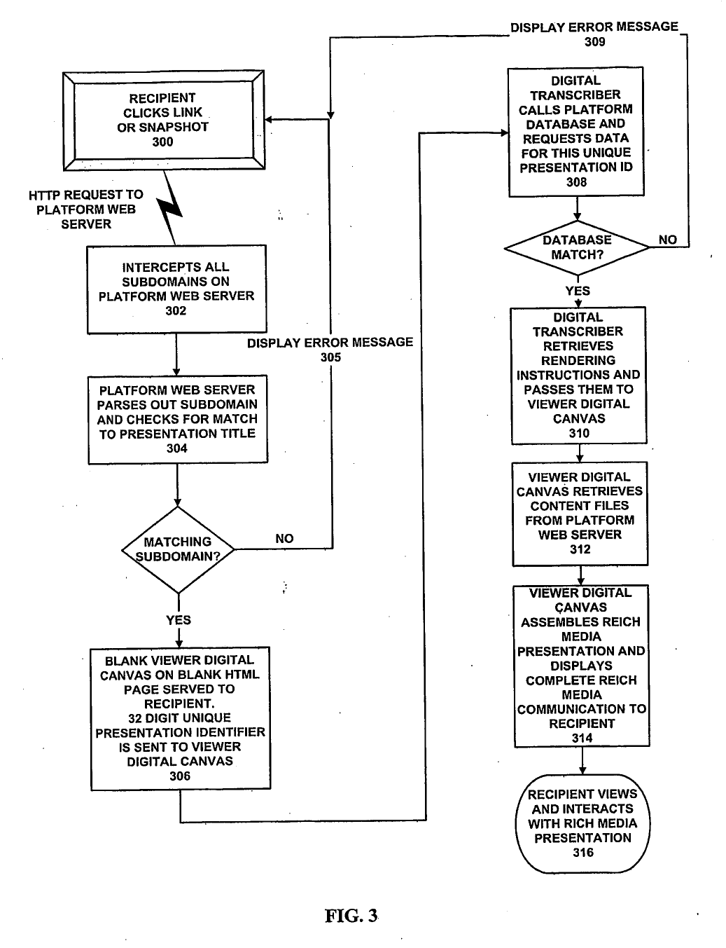

The process of rendering the Rich Media Presentation to the recipient 106 is depicted in FIG. 3. When a recipient of an email invitation to view a Rich Media Presentation clicks the presentation's URL, step 300, the Platform Web Server intercepts all sub domains, step 302, parses out the sub domain contained within the URL and checks for the sub domain matching the Presentation's title, step 304. If a matching sub domain is found, the Platform Web Server sends the 32-digit unique identifier (the Presentation ID) for the presentation to the blank Viewer Digital Canvas that displays briefly to the viewer 106, step 306 while the events in the code send a request to the Digital Transcriber to retrieve the rendering instructions from the Platform Database 104 indexed with this 32-digit ID, step 308. Once the matching database record is located, the Digital Transcriber retrieves the instruction set from the Platform Database and returns it to the Viewer Digital Canvas to locate and retrieve the content files from the Platform Web Server 102, step 312. The Viewer Digital Canvas then assembles the content elements and displays them as a Rich Media Presentation to the recipient 314 in the recipient's browser. Playback begins and the recipient, who is now considered the viewer of the presentation rendered by the Viewer Digital Canvas, interacts with the presentation 316.

In most cases, the rendering of the presentation on the client's computer at runtime is accomplished in near real time in a DSL or cable broadband connection. Recent tests of the illustrative embodiment were conducted with what might be considered a “worse-case scenario” where the recipient has limited bandwidth. These tests were conducted on a platform using an HP Brio Pentium 3 computer running Windows 98 and connected to the Internet on a 49 kb dial-up connection.

Using a demonstration presentation, our tests showed that the Rich Media Presentation loaded within 20 seconds of the first click on the hyperlinked Snapshot in an HTML email. This included the full Rich Media Presentation interface, all of the buttons and links (which were live) and a screen image of the Presentation. The video itself took just under 2 minutes to fully load and automatically begin playback.

As a comparison, the same dial-up platform was used to connect to both ABC News Video and CNN in order to view selected video clips. The video player backgrounds alone, with no links, images or other content elements unique to the selected video clips took 25 seconds to load for ABC and 17 seconds to load for CNN. After 3 minutes the ABC video still had not launched. On CNN, the video had not launched after a 5 minute wait.

To accomplish these exceptional rendering speeds, the invention's Viewer Digital Canvas 109 contains an embedded Flash file (SWF) that uses Flash ActionScript for processing tasks. The size of this SWF file is typically only 70K. When the SWF is first opened, the Rich Media Presentation is created on the viewer's computer by retrieving the instruction set from the Platform Database 104 and each of the rich media component files identified in the instructions from the Platform Web Server 102. The Viewer Digital Canvas then assembles the presentation and displays it in accordance with any customization options the implementer may have specified for the presentation. While the illustrative embodiment discusses the creation, updating, deployment and distribution of Rich Media Presentations, the present invention can be utilized to create different types of online digital communications, such as web pages that are rendered client side in real time.

Another aspect of the invention relates to the automatic embedding of code within each Rich Media Presentation, which is used to capture statistical information pertaining to the presentation recipient's interaction with the content elements of a Rich Media Presentation.

Each Rich Media Presentation content element is programmatically provided with the tracking mechanisms required to record this data by the Digital Transcriber without any involvement of the marketing communicator. The data recorded from viewer interaction with the Presentation is then automatically saved within the Platform Database 104 tables identified as being related to the Rich Media Communication. When a Rich Media Presentation is updated on the Digital Canvas through the Dashboard Content Manager 112, the tracking mechanisms for that Presentation are programmed to update themselves automatically. The updated Presentation and tracking instructions are collected and saved by the Digital Transcriber in the Database to be recalled and displayed by the Viewer Digital Canvas to viewers.

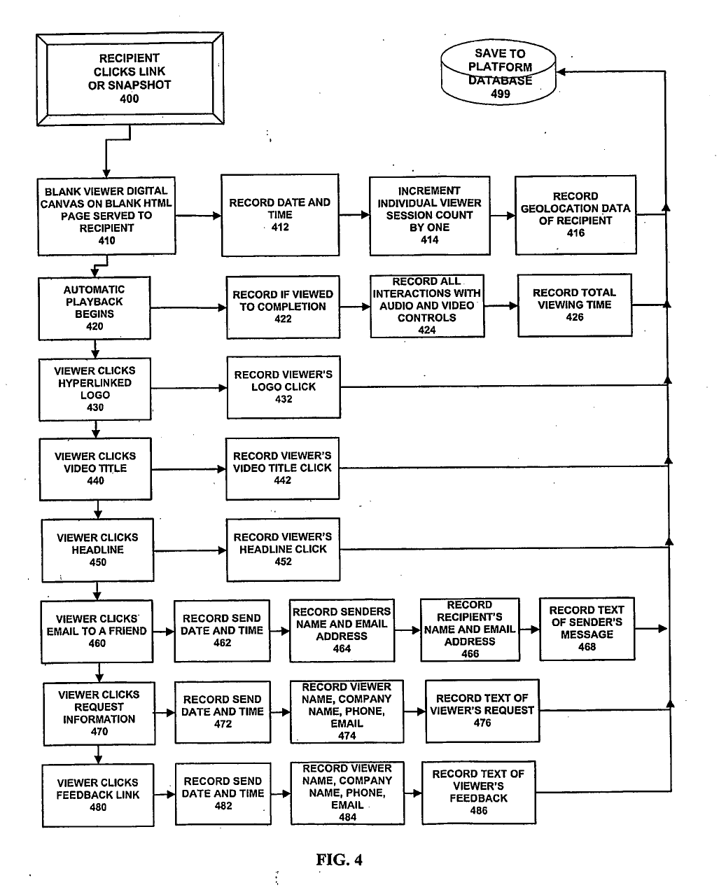

Each viewer's interactions with the Rich Media Communication are tracked and the data pertaining to these interactions is stored in the Platform Database 104. The tracking process, which is depicted in FIG. 4, begins when the email recipient clicks the hyperlinked Snapshot 400 and ends when the recipient exits the Rich Media Communication. Tracking data for each session is stored in the Platform Database 499.

When a recipient clicks the hyperlinked Snapshot, 400, he becomes a viewer and is assigned a unique Session ID and a blank Viewer Digital Canvas is displayed in the Viewer's browser 410. The date and time of the session are captured 412, the individual viewer session count is incremented for this presentation 414 and the geolocation information associated with or calculated from the Viewer's IP address are recorded 416.

Once the presentation is fully rendered in the Viewer's Internet browser, playback begins automatically 420. Once playback has begun, whenever a Rich Media Communication viewer initiates an activity within a Rich Media Presentation 112, such as clicking a link or starting and stopping a presentation 524, pre-coded Flash objects are triggered and a related event defined in the SWF ActionScript contained in the Rich Media Communication web page sends the data related to this action to a PHP file, which processes the data and saves it in a set of relational database tables associated with the Session ID within the Platform Database 499. All key data in each of the tables is indexed and may be subsequently retrieved, printed, or exported. Exported data may then later be imported into a spreadsheet, database, or other statistical or marketing analysis software tool.

In the illustrative embodiment, data pertaining to each Rich Media Presentation is presented in the form of summary data on the combined viewing sessions of all presentation viewing interactions, including the total viewing time for all visitors to the Rich Media Presentation, the number of times various buttons and links were clicked while the presentation was running, the date and time that the last click of these items occurred, the number of times the presentation was viewed to completion, the number of times the presentation started successfully, the number of times certain actions, such as the initiation of a request for more information, or the act of emailing the presentation to a friend were started but not completed, along with the number of times these acts were completed in their entirety.

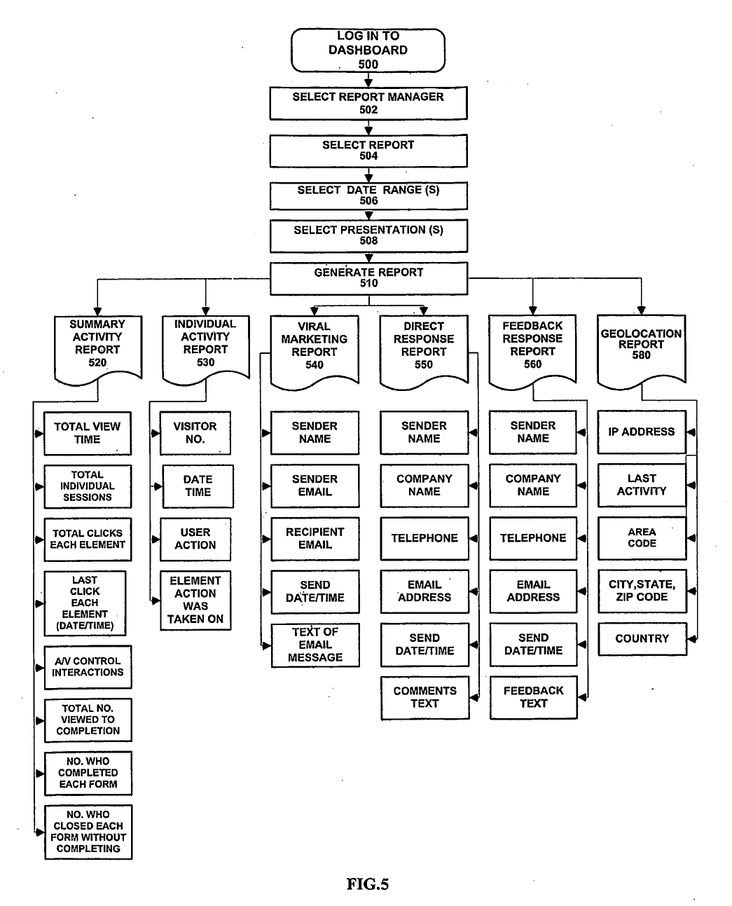

The Dashboard user is then able to retrieve the statistical data related to each Rich Media Presentation and create reports using the processes depicted in FIG. 5. To retrieve the data and generate a report within the Dashboard Report Manger 114 requires nothing more of the Dashboard User than to select a report 504, select one or more date ranges 506, select one or more Rich Media Presentations on which to report 508 and then to click a button to generate the report 510, which triggers PHP and MySQL queries that are used to retrieve the selected tracking data from the Platform Database 104.

The statistical data associated with the Dashboard user's Client ID, the selected Presentation's unique ID, and with the selected report is transmitted back to the Platform Web Server 102. Once the tracking statistics are retrieved from the Platform Database tables, the Dashboard's Report Manager displays a formatted report that contains the tracking data associated with the selected report for the specified date range(s). In the illustrative embodiment, the Dashboard user may select any of several reports including:
Summary Activity Report 520: Aggregates viewing time data, actual number of viewers, use of action buttons, viewer interaction and use of video content and other features for the selected date range (s). Frequency and time of day data are collected, reported and summarized on the following usage measurements:

viewing time, individual viewing sessions, buttons (e.g., PLAY, PAUSE, VOLUME, etc.) clicked, standard action buttons clicked (e.g., Email This Presentation 460, Learn More 470, Send Us Your Opinion 480), customized links clicked (e.g., logo 430, video title 440, textbox headline 450), unique viewers who watched video to completion 422, action button forms completed and sent (e.g., Email This Presentation form).
Individual Activity Report 530: Reports detailed viewer activity and interaction with the presentation on an individual user basis. This report includes Presentation Title, Date and Time of Action, and any specific Action taken by each individual user.
Viral Marketing Report 540: This report shows data collected when the Email Action Link is clicked 460 and an email is generated and sent by a Rich Media Presentation's viewer. This report includes the following data for each sent email: Presentation Title, Sender Name, Sender Email, Recipient Email, Send Date, and Message Content.
Direct Response Report 550: This report shows data collected when the Learn More Action Link 470 is clicked and the rich media presentation viewer submits a question or request for more information. This report includes the following data for each viewer request: Name, Company, Address, Telephone, Email Address, and the text of any comments, questions or requests.
Feedback Response Report 560: This report shows data collected when the Send Us Your Opinion Action Link 480 is clicked and the Rich Media Presentation's viewer submits feedback on the presentation. This report includes the following data for each viewer request: Name, Company, Email Address and the feedback text submitted by each viewer.
Geo-location Report 580: This report shows the data collected for each visitor when a Rich Media Communication is opened in a browser 410, including IP Address, Date and Time of Last Activity. Area code, City, State, Zip code and Country for each individual viewer of the presentation.

Another feature of the present invention is that the tracking mechanisms used for each Rich Media Communication are automatically updated when a Rich Media Presentation is updated using the Digital Canvas 116. This feature of the invention is made possible through the use of dynamic Flash ActionScript objects programmed into the Digital Canvas 116 that are automatically attached to each content element when a content element is created or updated using the Dashboard Content Manager 112 and following the processes shown in FIG. 2. By using such dynamic objects that automatically attach themselves to design elements as a result of events that occur during the creation and editing processes, the tracking capability of audiovisual presentations is easily maintained without any knowledge of computer programming or databases on the part of the user.

In the illustrative embodiment, a single database is used for all customers and all Rich Media Presentations and both statistical data and content elements are stored in the same database, which indexes stored information by Client ID and by the unique ID of the Rich Media Presentation. However, an embodiment may be configured in a distributed environment where tracking statistics and content elements are stored in a collection of distributed databases located on one or more servers, both for scalability and for failover purposes.

In an example scenario of an illustrative embodiment of the invention, an administrator from a direct marketing firm, who will be referred to as “Dashboard User 1” for this example, distributes a Rich Media Presentation HTML email that contains a Snapshot of the Presentation, referred to as Presentation 1 in this illustration, to prospective customers as part of a marketing campaign.

This HTML email Snapshot that was created by Dashboard User 1 in the Dashboard Content Manager 112 component of the User Dashboard contains a link to the unique title of Presentation 1, equivalent to the sub domain of the URL of the marketing company's Presentation 1. A prospect or recipient, who will be referred to as “Prospect” for this example, receives the email containing the hyperlinked Snapshot image of Presentation 1 and clicks the image to open Presentation 1 within a Rich Media Communication web page.

Opening the Presentation URL activates the Viewer Digital Canvas 109, which sends a request to Platform Web Server 102, which then matches the sub domain in the request URL 304 to Presentation 1 for Dashboard User 1. Once the Platform Web Server confirms that the sub domain exists the Platform Web Server sends the 32-digit unique identifier for the presentation stored in the Platform Database 104 to the blank Viewer Digital Canvas that displays in the browser. A unique session ID is created by the Platform Web Server 102 and the Flash ActionScript contained in the Viewer Digital Canvas, which is now loaded within Prospect's browser 306, sends a request to the Digital Transcriber 120 to retrieve the rendering instructions indexed with Presentation 1's 32-digit ID 308 from the Platform Database 104. The Digital Transcriber then passes these rendering instructions to the Viewer Digital Canvas, which uses the instruction set to locate and retrieve the content files from the Platform Web Server 102. The Viewer Digital Canvas then assembles the content elements and renders them in their specified arrangement as a Rich Media Presentation (Presentation 1) within a Rich Media Communication web page 110 to Prospect 106. Any video portions of the Presentation begin playback automatically 420.

Tracking information, including the Prospect's IP address as well as the date and time Presentation 1 was opened 412, is captured and stored in database tables for Dashboard User's later retrieval and analysis in, the Dashboard Report Manager 114.

Prospect clicks on a Send Us Your Opinion feedback Action Link 480 that Dashboard User placed on Presentation 1 at design time. The Feedback form is displayed on top of Presentation 1. Prospect completes the Feedback form providing his first name, last name, company name, email address and types his feedback comments and then clicks Send.

When Prospect clicks Send, the form data provided by Prospect is sent to Platform Web Server 102 by Flash ActionScript, processed by PHP files, and inserted into the related database tables 499 of the Platform Database 104 so that it is available for later retrieval by Dashboard User through the Dashboard Report Manager 114.

A confirmation message is displayed to Prospect, who accepts the confirmation by clicking OK within the confirmation message. The confirmation message window closes and Prospect is returned to Presentation 1 Prospect then clicks the Email This Presentation Action Link 460 the Dashboard User placed on Presentation 1 through the Content Manager component of the User Dashboard at design time. The Email This Presentation form is displayed in a popup window. Prospect completes this form by typing his name, his own email address, his friend's email address, and optionally, any comments that Prospect wants to be displayed when Prospect's friend opens this email message and then clicks Send. When Prospect clicks Send, the Flash ActionScript sends the information to an associated PHP file on Platform Web server 102. This PHP file processes the data supplied by Prospect and inserts the data into the Platform Database 499.

The Platform Web Server 102 uses the configured email SMTP system to send an HTML email message to Prospect's friend's email address containing the text that Prospect typed and a static Snapshot of Presentation 1, selected by the Dashboard User in the Dashboard Content Manager 266, is rendered as a web-compatible JPG image, which is hyperlinked to open the associated Rich Media Communication web page that contains Presentation 1.

Prospect clicks OK in the confirmation message to close the confirmation pop-up window. Prospect is returned to Presentation 1 and then clicks either a text hyperlink formatted to be a bold-faced Headline 450, or a text hyperlink Video Title 440 specified by Dashboard User for Presentation 1 in the Dashboard Content Manager 228 or 226 component of the User Dashboard. A new browser window opens to launch the web page associated with the URL at design time. Either of these actions simultaneously triggers events where Flash ActionScript calls an associated PHP file, which processes the click information and stores it in the appropriate Platform Database 499 tables for later retrieval through the Dashboard Report Manager 114.

Dashboard User opens an Internet browser and logs on 500 to his company's account on Platform Web Server 102. Platform Web Server authenticates Dashboard User and displays Dashboard User's Dashboard.

Dashboard User clicks the Dashboard's Report Manager tab 502. Once Dashboard User selects a report 504, specifies one or more date ranges 506, selects Presentation 1 (508), and then clicks Generate Report 510, the Platform Web Server 102 retrieves the tracking data from the Platform Database 104 that applies to the Client ID associated with Dashboard User and the unique ID for Presentation 1.

The Dashboard statistics reflect Prospect's actions and the actions of any other visitors of Dashboard User's Rich Media Communication web page used for Presentation 1. Geolocation information, including the area code, city, state, and country associated with the visitor's IP address is displayed when Dashboard User clicks the Geolocation Report 580 link, specifies one or more date ranges 506, selects Presentation 1 (508) and then clicks Generate Report 510. Presentation 1's statistics are displayed and include the geolocation information for Prospect 416 and other Web site visitors with respect to this unique Presentation ID.

Dashboard User clicks the Viral Marketing Report 540 link, selects one or more date ranges 506 for the report, selects Presentation 1 (508) and then clicks Generate Report 510. Prospect's name and email address are shown along with Prospect's friend's email address and any text comments provided by Prospect that accompanied the email to Prospect's friend 460.

Dashboard User clicks the Feedback Response Report 560 link in the Report Manager component of the Dashboard, selects one or more date ranges 506, selects Presentation 1 (508) and then clicks Generate Report 510. The information provided by Prospect when Prospect clicked the Send Us Your Opinion 480 link within Presentation 1 and completed the Feedback form is displayed to Dashboard User in the report displayed in the Report Manager component of the User Dashboard. Dashboard User has the option to print the statistical data or save the data as a CSV (comma separated values) or other type of file that can later be imported into a database, spreadsheet, or reporting software application.

Prospect's friend opens his email client on his computer. A message is waiting in the Friend's 1 inbox. The subject line of the mail message reads, “You Have Been Sent A Rich Media Video Email About Dashboard User's Product”. Prospect's friend opens this email message. The From field of the email displays Prospect's email address. The body of the email displays the Snapshot associated with Presentation 1. The Snapshot along with some text in the email is hyperlinked to open Dashboard User's Presentation 1. When clicked by Prospect's friend, this link directs Prospect's friend's browser to the unique sub domain for Presentation 1 located on the Platform Web Server and the process of opening a session, communicating with the Platform Database, retrieving and assembling content elements, and recording and storing statistical data that occurred when Prospect first viewed the Presentation is repeated.

The computer system, methods, and technology platform described in this preferred embodiment provide a web-based system that is capable of quickly and efficiently creating user accounts, automatically creating sub domains from unique presentation titles, dynamically assembling and updating high quality, robust, multimedia presentations client side at runtime, as well as customizing the display of such presentations and customizing actions that occur when certain runtime events are triggered by recipients, all without computer programming knowledge on the part of the user of the invention. Further, the interactions of Rich Media Presentation recipients that generate valuable individual and summary usage data, viral marketing data, feedback information and lead capture, as well as record and store geolocation data of the Rich Media Presentation's recipients, along with information about the popularity of a specific Presentation, are tracked automatically without any intervention by the user of the invention.

The invention's platform components offer a great deal of flexibility to Marketing personnel and other web site operators and communicators, while reducing the overhead traditionally associated with fully customizing, coding, updating, tracking and deploying such rich media presentations. Therefore, the cost for conducting such direct marketing and media campaigns is reduced significantly, while meaningful data is made available to gauge the effectiveness of such campaigns, for lead generation, and for other analytical purposes. Additionally, we believe that the substantial reduction in the time and technical knowledge required to create and update these presentations “on the fly”—over the Internet, 24 hours per day and 7 days per week—will greatly contribute to continued advancements in these fields of endeavor.

While the invention has been described with reference to exemplary embodiments related to Rich Media Presentations, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiments disclosed for carrying out this invention's claims.

What is claimed is:

1. A system for creating a rich media communication to display to a viewer on an internet browser, said system comprising:
a digital canvas, responsive to interactions from a user, to provide for placement of media components in order to form said rich media communication;
a digital transcriber, in communication with said digital canvas, said digital transcriber to record said interactions from a user, to produce an instruction set, said instruction set describing said media components so as to render said rich media communication;
wherein when a viewer is to view said rich media communication, said system presents said digital canvas to said user, and loads said instruction set into said digital canvas, to render said rich media communication.

2. The system of claim 1 wherein said rich media communication is presented to said viewer by sending said digital canvas to said viewer's internet browser, then loading said instruction set into said digital canvas, wherein said digital canvas retrieves said media components over the internet.

3. The system of claim 2 wherein said viewer is provided with a unique identifier, said unique identifier identifying a selected rich media communication to present to said viewer.

4. The system of claim 1 further including:
a snapshot canvas, responsive to said instruction set, to render said rich media communication for display to said user, wherein said user may designate a certain frame of said rich media communication and save said designated frame as a static image.

5. The system of claim 1 wherein a viewer canvas is presented to said viewer, wherein said viewer canvas includes a lesser functionality level than a functionality level of said digital canvas.

6. The system of claim 1 wherein said media components include video, images, text, background elements, links, buttons, and audio.

7. The system of claim 2 wherein viewer interactions with the rich media communication are provided to said system by said digital canvas running on said viewer's internet browser.

8. A method of creating a rich media communication to display to a viewer on an internet browser, said method comprising:
providing a digital canvas, said digital canvas allowing placement of media components in order to form said rich media communication;
recording user interactions with said digital canvas, and transcribing said interactions into an instruction set, said instruction set describing said media components so as to render said rich media communication;
delivering said digital canvas to said viewer; and
delivering said instruction set into said digital canvas, wherein when said instruction set is loaded into said digital canvas, said digital canvas retrieves said media components over the internet, and renders said rich media communication.

9. The method of claim 8 further including:
providing a snapshot canvas, and loading said instruction set into said snapshot canvas, to render said rich media communication; and
responding to an indication from said user, to capture a frame of said rich media communication and save said designated frame as a static image.

10. The method of claim 8 further including:
recording viewer interactions with the rich media communication, and storing said viewer interactions in a database for analysis.
